(19) United States
(12) Patent Application Publication
(10) Pub. No.: US 2004/0069098 A1
(43) Pub. Date: Apr. 15, 2004

(54) Structure of a wrench

(76) Inventor: Kuo Chung Chang, Taipei (TW)

Correspondence Address: CHANG Kuo Chung, PO Box 82-144, TAIPEI, TW

(21) Appl. No.: 10/267,732

(22) Filed: Oct. 10, 2002

(51) Int. Cl. B25B 13/46

(52) U.S. Cl. 81/60

(57) ABSTRACT

An improvement structure of a wrench includes a wrench body having an elongated handle provided with a cavity hole at one end opposite to one end of the handle, a control body substantially cylindrical which can be mounted into the cavity hole of the handle, a press body passed through the through hole of the control body and being provided with a threaded section, and the bottom edge of the press body being provided with a plurality of mounting slots, and a plurality of clipping block having a number being equal to the number of the clipping slots of the control body, thereby providing a wrench for which the size for mounting hole is adjustable to fit onto screw elements of various specifications and the wrench directly drives the screw elements.

### BACKGROUND OF THE INVENTION

(a) Field of the Invention

The present invention relates to an improved structure of a wrench, and in particular, a wrench for which the size for mounting hole is adjustable to fit onto screw elements of various specifications and the wrench directly drives the screw elements.

(b) Description of the Prior Art

Conventionally, after a socket is mounted onto a wrench and a screw element is inserted into the socket, the wrench is rotated in order to unfasten or fasten the screw element. The wrench and the socket have to match with each other in order to rotate a screw element if there is a wrench and a socket is not available to fit to the wrench, the wrench cannot be operated. This is a drawback of the conventional wrench.

Taiwanese Patent Application No. 86208212 discloses a wrench capable of direct driving a screw element and the wrench is adjustable to combine with the screw element. However, this convention has the following drawback:

The two clipping blocks having a lower edge can be adjusted in order to comply with screw element of various specifications. However, in the course of rotating of the wrench, the two clipping blocks has the upper edge to connect with the oval shape rotating disc, the resistance of the screw element is transferred to the connection between the clipping block and the rotating disc, the torque provided by this wrench is very limited and in mechanic, the point of resistance and the point of force resistance are located on the same line and shear is produced.

### SUMMARY OF THE INVENTION

Accordingly, it is an object of the present invention to provide an improved structure of a wrench, wherein the drawback of insufficient stress can be overcome.

Yet another improvement structure of a wrench comprising a wrench body having an elongated handle provided with a cavity hole at one end opposite to one end of the handle; a control body substantially cylindrical which can be mounted into the cavity hole of the handle, the center of the control body being a through hole and the outer edge of the upper end of the control body being provided with a mounting edge and the center of the outer circumferential edge of the control body being the engaging teeth to provide a function of the ratchet wheel when the wrench body is rotated, the lower end of the engaging teeth of the control body being a screwing section and the bottom end of the control body being a conic shape protruded block having an outer circumferential edge being a plurality of clipping slots, the clipping slot being in communication with the through hole of the control body, and the interior of the clipping slot being provided with a resisting edge; a press body passed through the through hole of the control body and being provided with a threaded section, and the bottom edge of the press body being provided with a plurality of mounting slots, and the number of mounting slots being equal to the numbers of the control body, the clipping slots and the mounting slot being mounted with a plurality of clipping blocks; and a plurality of clipping blocks having a number being equal to the number of the clipping slots of the control body, the top end of the clipping block being a mounting edge for the combination with the mounting slot of the press body so as to mount onto the mounting slot of the press body, the lower end of the clipping block being inserted into a plurality of clipping slots of the control body the two lateral sides of the clipping blocks being provided with two wings to urge against the resisting edge of the clipping slot; a housing being a circular shape having an upper end with a screwing section at the interior thereof for mounting together with the screwing section of the control body, so that the housing being formed into a conic shape by the protruded block and the control body and the housing prevented the clipping block from dislocation from the clipping slot of the control body. Thereby, a cavity space is formed between a plurality of the clipping blocks for mounting with the screw element for rotating, if the press body is pressed, the press body drives the clipping block to move downward along the clipping slot, due to the protruded block at the outer circumferential edge is provided with a conic shape housing, when the plurality of clipping blocks approach one another, a smaller screw element can be mounted and be driven.

Other object and advantages of the present invention will become more apparent from the following description taken in conjunction with the accompanying drawing.

### BRIEF DESCRIPTION OF THE DRAWINGS

FIG. 1 is a perspective exploded view of the wrench of the present invention.

FIG. 2 is a partial sectional view of the wrench of the present invention.

FIG. 3 is a sectional view showing the relationship of the elements of the wrench of the present invention.

FIG. 4 is a perspective view of the wrench of the present invention.

FIG. 5 is a sectional view schematically showing the rotating of nut of the maximum size in accordance with the present invention.

FIG. 6 is a partial sectional view schematically showing the rotating of nut of the maximum size in accordance with the present invention.

FIG. 7 is a sectional view schematically showing the rotating of nut of another size in accordance with the present invention.

FIG. 8 is a partial sectional view schematically showing the rotating of nut of another size in accordance with the present invention.

FIG. 9 is a partial sectional view of a second preferred embodiment of the present invention.

FIG. 10 is a perspective exploded view of a third preferred embodiment of the present invention.

### DETAILED DESCRIPTION OF THE PRESENT INVENTION

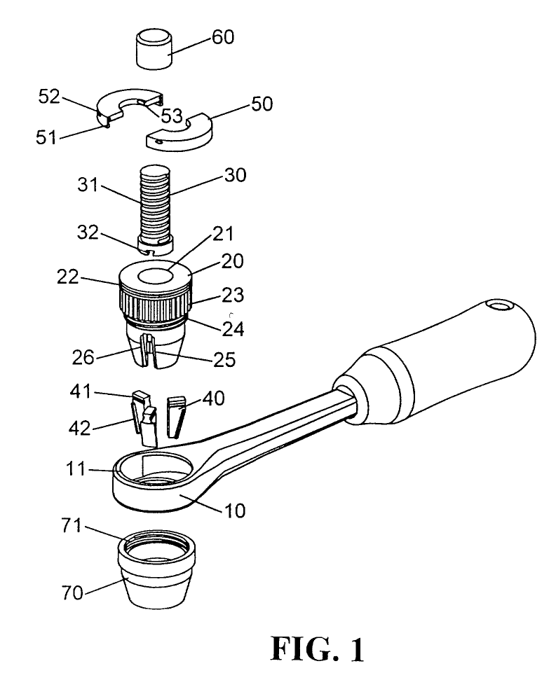

Referring to FIG. 1, there is shown an improved structure of a wrench comprising

(a) a wrench body 10 having an elongated handle provided with a cavity hole 11 at one end opposite to the one end of the handle;

(b) a control body 20 substantially cylindrical which can be mounted into the cavity hole 11 of the handle, the center of the control body 20 being a through hole 21 and the outer edge of the upper end of the control body 20 being provided with a mounting edge 22 and the center of the outer circumferential edge of the control body being the engaging teeth 23 to provide a function of the ratchet wheel when the wrench body 10 is rotated, the lower end of the engaging teeth of the control body 20 being a screwing section 24 and the bottom end of the control body 20 being a conic shape protruded block 27 having an outer circumferential edge being a plurality of clipping slots 25, the clipping slot 25 being in communication with the through hole 21 of the control body 20, and the interior of the clipping slot 25 being provided with a resisting edge 26;

(c) a press body 30 passed through the through hole 21 of the control body 20 and being provided with a threaded section 31, and the bottom edge of the press body 30 being provided with a plurality of mounting slot 32, and the number of mounting slots being 32 equal to the numbers of the control body, the clipping slots 25, and the mounting slot 32 is mounted with a plurality of clipping blocks 40;

(d) a plurality of clipping block a number being equal to the number of the clipping slots 25 of the control body 20, the top end of the clipping block 40 being a mounting edge 41 for the combination with the mounting slot 32 of the press body so as to mount onto the mounting slot 32 of the press body 30, the lower end of the clipping block 40 being inserted into a plurality of clipping slots 25 of the control body 20, the two lateral sides of the clipping block 40 being provided with two wings 42 to urge against the resisting edge 26 of the clipping slot 25;

(e) a housing 70 being a circular shape having an upper end with a screwing section at the interior thereof for mounting together with the screwing section 24 of the control body 20 so that the housing 70 being formed into a conic shape by the protruded block 27 and the control body 20 and the housing 70 prevented the clipping block 40 from dislocation from the clipping slot 25 of the control body 20;

(f) a plurality of rotating bodies 50 having the lower end thereof being provided with the mounting edge 51 to combine with the mounting edge 22 at the upper end of the control body 20 and being pivotally mounted at the mounting edge 22 of the control body 20, the rotating bodies 50 being mounted to each other by installation hole 52, the rotating body 50 being provided with a protruded block 53 which is slightly contacted the thread section 31 of the press body 30; and

(g) an upper rotating body 60 being a hollow structure mounted onto the rotating body 60.

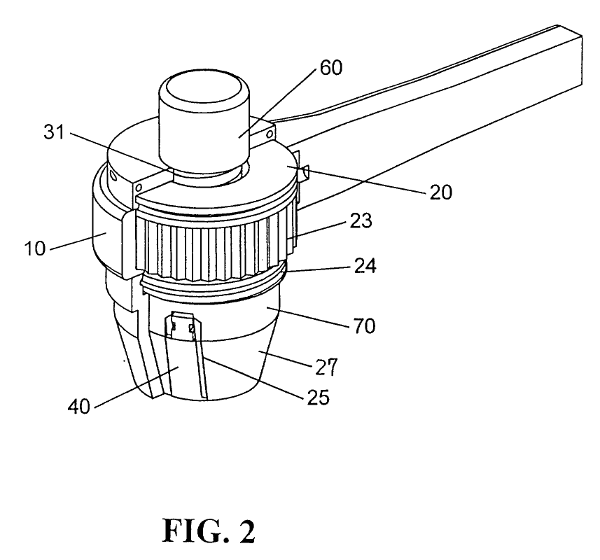

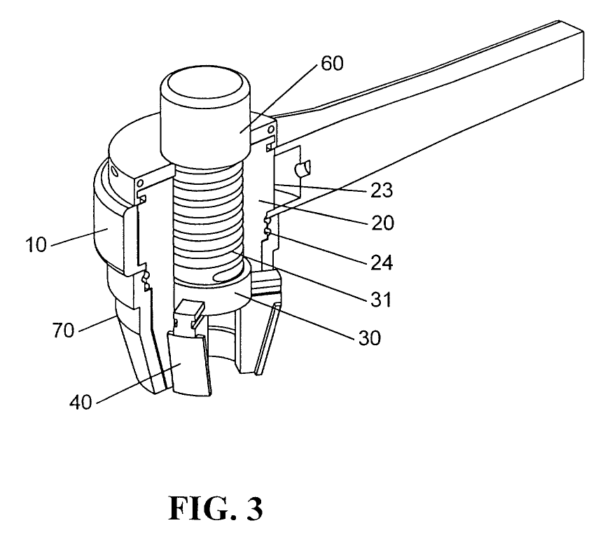

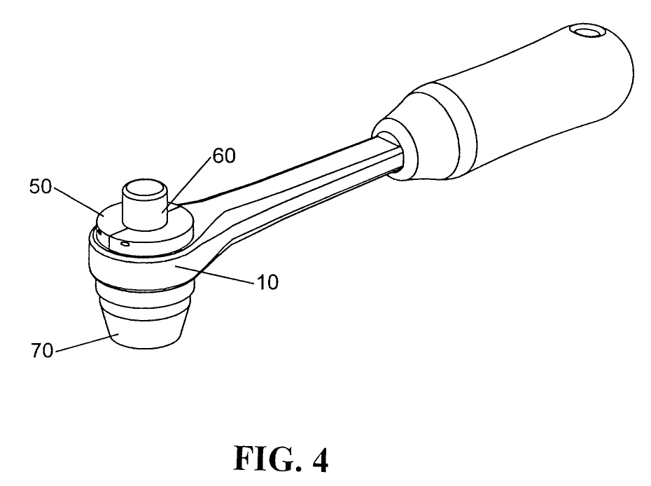

In accordance with the present invention, (referring to FIGS. 2 and 3), FIG. 2 shows the sectional view of the wrench body 10 and the housing 70 and FIG. 3 shows the sectional view of the wrench body 10, a control body 20, and a housing 70. In combination, the control body 20 is inserted into the cavity hole 11 of the wrench 10, and the press body 30 is inserted into the through hole 21 of the control body 20. A plurality of clipping blocks 40 is then inserted into the clipping slot 25 of the control body 20. When the clipping block 40 is inserted into the clipping slot 25 of the control body 20, the mounting edge 41 of the clipping block 40 is inserted into the mounting slot 32 of the press body 30 at the interior of the through hole 21 of the control body 20. The two wings 42 of the clipping block 40 urge against the resisting edge 26 of the clipping slot 25, such that the clipping block 40 will not fall into the through hole 21 of the control body 20. The control body 20 is then screwed with the housing 70 such that the clipping block 40 will not be dislocated. The upper end of the control body 20 is pivotally mounted with a plurality of rotating bodies 50 and the rotating bodies 50 are then mounted onto the rotating body 60. The complete wrench structure of the present invention is shown in FIG. 4.

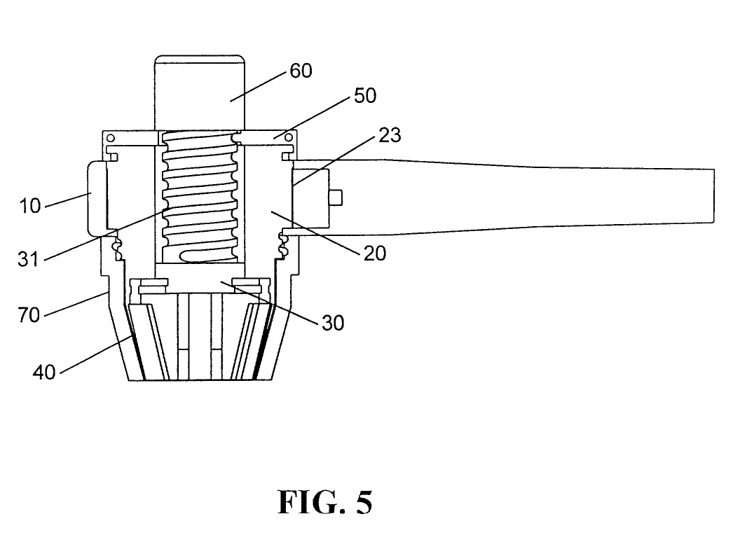

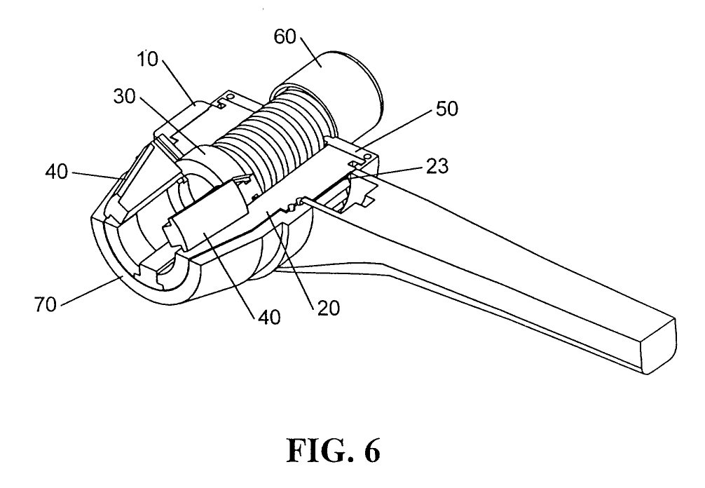

FIGS. 5 and 6 show the operation of the wrench structure in accordance with the present invention. When the press body 30 is located at the uppermost position, and the clipping block 40 is located at the uppermost position, the clipping block 40 is formed into a cavity space. This space allows the mounting of the screwing elements. Accordingly, the wrench body 10 can be directly rotated to mount a nut.

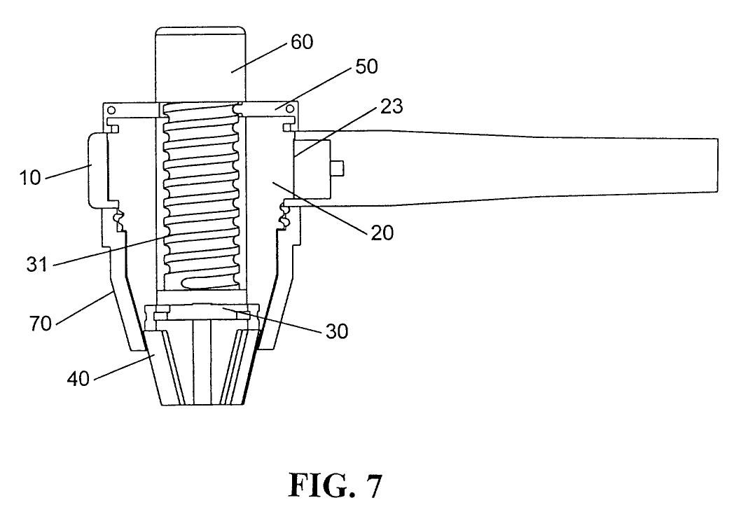

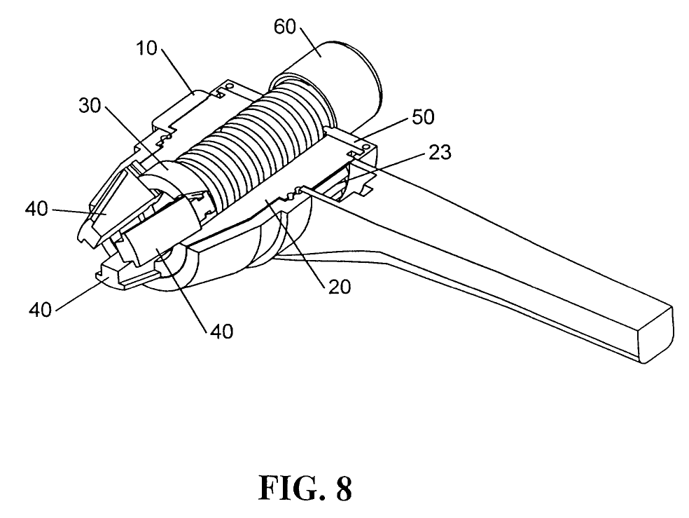

When the rotating body 50 or the rotating body 60 is rotated, the protruded block 53 of the rotating body 50 is in contact with the thread portion 31 of the press body 30, then, the press body 30 will move downward and the downward movement of the press body 30 will drive the clipping block 40 downward. The clipping block 40 will move downward along the clipping slot 25 of the control body 20. As the outer circumferential edge of the protruded block 27 of the control body 20 is provided with a conic housing 70, thus, when the clipping block 40 moves downward, the clipping block 40 moves closer to each other and the distance becomes smaller. Thus, a small size nut element can be mounted for rotating. This is shown in FIGS. 7 and 8.

Referring to FIG. 5, when the stress is provided with load, the screw element is a resistance. Then, the clipping block 40 bears all the stress and after the clipping block 40 clips to the screw element, the external edge of the clipping block 40 urges against the housing 70, and the stress of the clipping block 40 is bear by all the contact surface of the clipping block 40 and the housing 70. If there are three clipping blocks 40, all the contact surface of the clipping block 40 and the housing 70 is large. Thus the rotating of the screw element can bear relatively large stress. As shown in FIG. 7, the clipping block 40 moves downward and all the contact surface of the clipping block 40 and the housing 70 is reduced. Thus, the stress is relatively smaller. When the clipping block 40 moves downward, the relative space between the clipping blocks 40 become small and a small screw element can be fastened. Thus, the stress is smaller and the smaller screw element requires only a small stress.

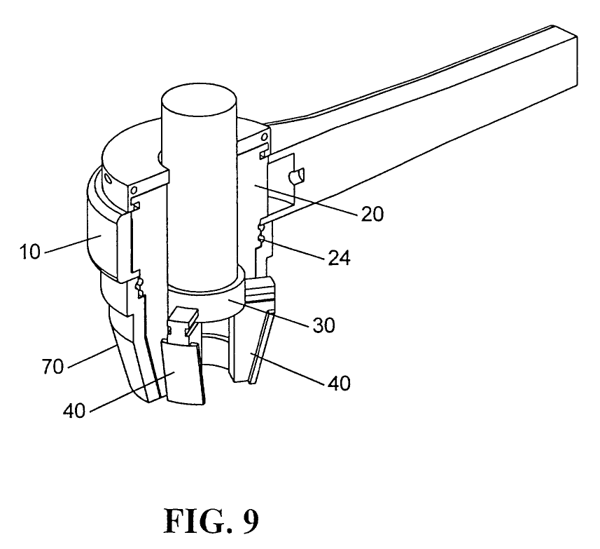

Referring to FIG. 9, there is shown a second preferred embodiment of the present invention. The rotating body 60 is not in use in this preferred embodiment, and the press body 30 is not provided with a thread section 31. In operation, the press body 30 is pressed directly, the clipping block 40 moves downward and the size thereof is adjustable. In this preferred embodiment, the pressing of the press body 30 can hardly control the distance between the individual clipping blocks 40.

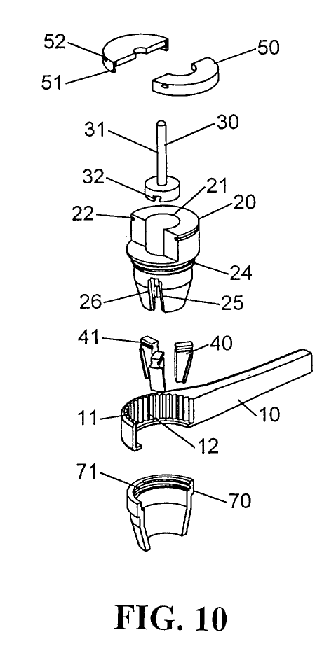

Referring to FIG. 10, there is shown a third preferred embodiment of the present invention. In this preferred embodiment, the control body 20 is not provided with the engaging teeth 23 and the inner circumferential edge of the cavity hole of the wrench body 10 is provided with circular teeth. This structure will also provide the function of a ratchet wheel.

While the invention has been described with respect to preferred embodiment, it will be clear to those skilled in the art that modifications and improvements may be made to the invention without departing from the spirit and scope of the invention. Therefore, the invention is not to be limited by the specific illustrative embodiment, but only by the scope of the appended claims.

I claim:

1. An improvement structure of a wrench comprising
(a) a wrench body having an elongated handle provided with a cavity hole at one end opposite to one end of the handle;
(b) a control body substantially cylindrical which can be mounted into the cavity hole of the handle, the center of the control body being a through hole and the outer edge of the upper end of the control body being provided with a mounting edge and the center of the outer circumferential edge of the control body being the engaging teeth to provide a function of the ratchet wheel when the wrench body is rotated, the lower end of the engaging teeth of the control body being a screwing section and the bottom end of the control body being a conic shape protruded block having an outer circumferential edge being a plurality of clipping slots, the clipping slot being in communication with the through hole of the control body, and the interior of the clipping slot being provided with a resisting edge;
(c) a press body passed through the through hole of the control body and being provided with a threaded section, and the bottom edge of the press body being provided with a plurality of mounting slots, and the number of mounting slots being equal to the numbers of the control body, the clipping slots and the mounting slot being mounted with a plurality of clipping blocks; and
(d) a plurality of clipping block having a number being equal to the number of the clipping slots of the control body, the top end of the clipping block being a mounting edge for the combination with the mounting slot of the press body so as to mount onto the mounting slot of the press body, the lower end of the clipping block being inserted into a plurality of clipping slots of the control body the two lateral sides of the clipping block being provided with two wings to urge against the resisting edge of the clipping slot;
(e) a housing being a circular shape having an upper end with a screwing section at the interior thereof for mounting together with the screwing section of the control body, so that the housing being formed into a conic shape by the protruded block and the control body and the housing prevented the clipping block from dislocation from the clipping slot of the control body;
thereby, a cavity space is formed between a plurality of the clipping blocks for mounting with the screw element for rotating, if the press body is pressed, the press body drives the clipping block to move downward along the clipping slot, due to the protruded block at the outer circumferential edge is provided with a conic shape housing, when the plurality of clipping blocks approach one another, a smaller screw element can be mounted and be driven.

2. An improved structure of a wrench as set forth in claim 1, wherein the downward control structure of the press body and the press body are provided with a threaded section, and the outer circumferential edge of the upper end of the control body is provided with a mounting edge for the pivotal mounting of a plurality of rotating body, and the rotating body is provided with a protruded block directly in contact with the threaded section of the press body.

3. An improved structure of a wrench as set forth in claim 1, wherein the center outer circumferential edge of the control body is provided with engaging teeth for the engagement with the wrench body.

4. An improved structure of a wrench as set forth in claim 1, the bottom edge of the press body is provided with a plurality of mounting slots and the upper end of the clipping block is formed into a mounting edge to comply with the mounting slots.

5. An improved structure of a wrench as set forth in claim 1, wherein the lower end of the engaging teeth of the control body is a screwing section for secure to the housing.

6. An improved structure of a wrench as set forth in claim 1 or 2, wherein the rotating body is provided with a top rotating body.

7. An improved structure of a wrench as set forth in claim 1 or 2, wherein an installation hole is provided between the rotating body allowing the mounting thereof to form a unit and the rotating body will not be dislocated from the control body.

8. An improved structure of a wrench as set forth in claim 1, wherein the number of the clipping blocks and the clipping slots are three each.

9. An improved structure of a wrench as set forth in claim 1, wherein the inner circumferential edge of the cavity hole has circular teeth providing a ratchet-wheel function.

10. An improved structure of a wrench as set forth in claim 1, wherein the other end of the wrench body can be mounted together with an opened and wrench.
